(19) United States
(12) Patent Application Publication
(10) Pub. No.: US 2010/0323063 A1
(43) Pub. Date: Dec. 23, 2010

(54) PROCESS FOR THE PREPARATION OF ISOMALTOOLIGOSACCHARIDE-HYDROGENATED

(75) Inventors: JiHang Lee, Icheon-si (KR); HeaSeok Jeong, Icheon-si (KR); HyukKon Kwon, Icheon-si (KR)

Correspondence Address: FOLEY & LARDNER LLP, 150 EAST GILMAN STREET, P.O. BOX 1497, MADISON, WI, 53701-1497, US

(73) Assignee: CORN PRODUCTS INTERNATIONAL, INC., Westchester, IL (US)

(21) Appl. No.: 12/811,188

(22) PCT Filed: Jan. 4, 2008
(86) PCT No.: PCT/US2008/050202

§ 371 Date: Aug. 25, 2010

(51) Int. Cl. A23L 1/236

(52) U.S. Cl. 426/48

(57) ABSTRACT

Processes for preparing isomaltooligosaccharide-hydrogenated (‘IMO-H’) syrup and IMO-H syrup made by the processes. In the process isomaltooligosaccharide (‘IMO’) is generally obtained by liquefying a raw material and then conducting one or more saccharification steps followed by additional processing steps, including filtration, decolorization, ion-exchange and evaporation. The IMO is then hydrogenated and the IMO-H is refined.

### BACKGROUND OF THE INVENTION

1. Field of the Invention

The invention pertains to processes for preparing sugar alcohol particularly isomaltooligosaccharide-hydrogenated (“IMO-H”). Generally, the processes comprise obtaining isomaltooligosaccharide (“IMO”) by liquefying a raw material and then conducting one or more saccharification steps followed by additional processing steps. The IMO is then hydrogenated.

2. The Related Art

IMO is a sweetener product that may be used in foods and beverages. Examples of the types of foods and beverages that may incorporate IMO as a sweetener are carbonated beverages, soy-milk, fruit drinks, tea, beer, wine, candies, chocolate, biscuits, cookies, cakes, bread and other similar products. The properties of IMO limit the application of IMO for commercial purposes.

IMO is preferably a white powder or clear syrup for application in foods. When IMO in powder form is heated the powder has a tendency to change to a slight yellow color under higher temperature undergoing a browning reaction. Further, amino acids may develop when the IMO is subjected to elevated temperatures. The browning reaction and/or the presence of amino acids may restrict the use of IMO in some food applications. For example, IMO which undergoes the browning reaction may not be fully used in beverages, particularly colored beverages due to discoloration effects from the off color IMO. Further, the browning reaction can cause undesirable discoloration of foods that are processed at high temperature. Also amino acids that can develop may have negative taste effects when used in beverages and foods.

There are additional concerns associated with IMO. IMO is digested to a certain degree by digestive enzymes in the small intestine of humans and thus has limited application as a prebiotic sweetener. Further, the sweet taste of IMO may be considered “thick” which affects the nature of foods and beverages comprising IMO and also may restrict its use in certain applications.

IMO-H tends to be stable at elevated temperatures and will not undergo browning reaction at processing temperatures and will not generate unwanted amino acids. Also, IMO-H is not digested by digestive enzymes in the small intestine and therefore passes through to the large intestine where the IMO-H may act as prebiotic and may be used in applications as an activator for fermentation of bifidobacteria and lactobacillus. Further conversion of IMO to the sugar alcohol, IMO-H, affects the sweetness profile in that the taste becomes thin and cool. Also, the calorie content of IMO is about 3.0 kcal/g to about 3.3 kcal/g whereas the calorie content of IMO-H is about 2.5 kcal/g which makes the lower calorie content sugar alcohol preferred for diet foods and beverages, as well as other applications.

Accordingly, IMO-H eliminates several concerns associated with IMO and is a more versatile sweetener for a broad range of applications. Thus, methods for obtaining IMO-H are desired.

All parts and percentages set forth in this specification and the claims are on a weight-by-weight basis unless otherwise specified.

### SUMMARY OF THE INVENTION

The processes comprise preparing IMO from a raw material and then hydrogenating the IMO. Raw materials include carbohydrates. Carbohydrates useful as a raw material for the invention include those selected from the group consisting of corn starch, wheat starch, tapioca starch, potato starch, sweet potato starch, sago starch, barley starch, rice starch, heat/acid treated starch (dextrin), pearl starch, waxy corn starch, sorghum starch, high amylose corn starch and liquid dextrose (preferably high solid content) and combinations thereof.

The processes for obtaining IMO-H generally comprise the following steps.

1. Forming a slurry of the raw material in liquid.

2. Liquefying the raw material, such as by treating the slurry with one or more liquefying enzymes, for example □-amylase.

3. Saccharification of the raw material to obtain IMO syrup, such as by treating the raw material with one or more saccharification enzymes, typically a saccharification enzyme selected from the group consisting of β-amylase, transglucosidase, pullulanase and combinations thereof. In embodiments of the invention saccharification is conducted in a first saccharification step and a second saccharification step.

4. Removal of foreign material, such as unreacted carbohydrate, typically denatured protein from the raw material, from the IMO syrup, i.e., from the liquid in the slurry. A means for removal like filtration, sedimentation, coagulation and the like and combinations thereof, which are capable of creating separate phases, including at least an IMO syrup phase and foreign material phase may be used.

5. Decoloration of the IMO syrup.

6. Separation of ionic components from the IMO syrup by a first means for separation which is capable of removing ionic species from the IMO syrup. In an embodiment of the invention the first means for separation comprises ion exchange.

7. Concentration of the IMO syrup to a desired moisture content and/or solids content, such as by a first means for removing a liquid which is capable of adjusting the moisture content and/or solids content of the IMO syrup. For example, evaporation of water from the IMO syrup to attain a desired moisture content and/or solids content.

The IMO syrup is then converted to IMO-H syrup. Initially, the IMO syrup, obtained as discussed above, is hydrogenated, preferably by use of a catalyst, such a nickel. After hydrogenation, the IMO-H syrup is subjected to a separation step to remove ionic components from the IMO-H syrup. This separation step for removal of ionic components from the IMO-H syrup is conducted in a second means for separation which is capable of removing ionic species from the IMO-H syrup, such as ionic exchange. After this separation step, the IMO-H syrup is subject to a final concentration step, such as by a second means for removing liquid which is capable of removing liquid and adjusting the moisture content and/or solids content of the IMO-H syrup. For example the IMO-H syrup can be concentrated to a desired moisture content and/or solids content by evaporation of liquid.

The process results in IMO-H syrup which may be used as a sweetener, such as a prebiotic sweetener, in many applications, such as in foods and beverages. For example, the IMO-syrup may be used in dairy products such as fermented beverage, yoghurt, baby foods and powdered milk. Also, the IMO-H syrup may be applied to health beverages as a prebiotic sweetener. The IMO-H syrup from the process will not under go browning reaction or generation of amino acids when subjected to elevated temperatures. Further, the IMO-H syrup obtained from the process will possess the benefits of IMO-H as discussed above.

### DETAILED DESCRIPTION OF THE INVENTION

The raw material for the process may be one or more carbohydrates, such as those selected from the group consisting of corn starch, wheat starch, tapioca starch, potato starch, sweet potato starch, sago starch, barley starch, rice starch, heat/acid treated starch (dextrin), pearl starch, waxy corn starch, sorghum starch, high amylose corn starch and liquid dextrose of high solid content and combinations thereof. The preferred raw material is starch, such as natural unmodified starch, with corn starch the most preferred raw material.

The process shall now be discussed with respect to carbohydrates, particularly starch, as the raw material. It should be understood, however, that this does not limit the scope of the invention which may applied to any of the raw materials discussed herein or other raw materials as may be apparent to those skilled in the art.

The raw material, i.e., carbohydrate such as starch, is combined with liquid, preferably water or a liquid comprising water, to obtain a slurry comprising carbohydrate and water. Generally, the density of the slurry should be about 10° Be′ to about 50° Be′, preferably about 18° Be′ to about 22° Be′.

After the slurry is formed, the carbohydrate is liquefied in that the insoluble components are converted to soluble material, such as through dextrinization. In an embodiment of the invention, one or more liquefying enzymes are added to the slurry. The liquefying enzyme may be added to the slurry, preferably automatically with an auto-pump, in amounts of about 0.40 kilogram enzyme per ton of starch (ds) to about 0.70 kilogram enzyme per ton of starch (ds), preferably about 0.50 kilogram enzyme per ton of starch (ds) to about 0.60 kilogram enzyme per ton of starch (ds) and typically in an amount of about 0.55 kilogram enzyme per ton of starch (ds). Typical enzyme dosages are about 0.015% to about 0.035%, preferably about 0.022% to about 0.025% liquefying enzyme (about 0.015 to about 0.035 kilogram liquefying enzyme per 100 kilograms of slurry, preferably about 0.022 to about 0.025 kilogram liquefying enzyme per 100 kilograms of slurry). The preferred liquefying enzyme is □-amylase, such as heat-stable □-amylase, most preferably liquid □-amylase, such as that available from Novo Nordsik (Denmark). The liquefying enzyme is reacted with the carbohydrate for a period of time at elevated temperature. For example, the reaction may occur at about 95° C. to about 125° C., typically about 100° C. to about 115° C., preferably about 105° C. to about 108° C. for up to about 3 hours, typically about 30 minutes to about 120 minutes, such as about 60 minutes to about 90 minutes. The pH is preferably maintained at about 5 to about 8, preferably about 5.8 to about 6.1 for the reaction, by the addition of NaOH to the slurry if the pH levels change during the reaction and need to be raised to remain within acceptable ranges.

After the liquefication is complete, the liquefied carbohydrate undergoes saccharification in one or more saccharification steps. The saccharification steps are generally performed by adding one or more saccharification enzymes to the slurry, such as one or more enzymes selected from the group consisting of β-amylase, □-amylase, transglucosidase, pullulanase and combinations thereof. Each saccharification step may be conducted for about 12 hours to about 120 hours, such as about 20 hours to about 72 hours at temperatures ranging from about 40° C. to about 90° C., typically about 50° C. to about 65° C., preferably about 55° C. to about 60° C. at an alkaline pH, such as about 4 to about 7, preferably about 5.0 to about 6.0, typically about 5.5 to about 5.8. For saccharification, pH is adjusted with acid, such as hydrochloric acid (HCl), but if the pH changes undesirably during the saccharification, alkali, such as sodium hydroxide (NaOH), is used to raise and maintain pH.

The amount of enzyme used in the saccharification steps is a function of the amount of dissolved maltose in the slurry. Generally, after liquefication of the carbohydrate, the dissolved maltose content of the slurry is checked and then an appropriate amount of enzyme is added for the saccharification. The amount of enzyme ranges from about 0.001% to about 0.15%, preferably is about 0.01% to about 0.10% based on the total weight of the slurry and typically 0.03% to about 0.07%. When β-amylase is applied as the saccharification enzyme, from about 0.01% to about 0.07%, typically about 0.03% is added to the slurry based on the total weight of the slurry. For transgluosidase about 0.07% to about 0.15% of the enzyme is added to the slurry, typically about 0.1% based on the total weight of the slurry. When pullulanase is used about 0.05% to about 0.1%, typically about 0.07%, of the enzyme is added to the slurry based on the total weight of the slurry. The saccharification enzyme is maybe added to the slurry manually.

In an embodiment of the invention, the process comprises a first saccharification step and a second saccharification step. The first saccharification step results in the production of maltose, preferably a maltose syrup, from the raw material in the slurry with the liquid. The first saccharification step comprises adding one or more first saccharification enzymes, such as β-amylase, pullulanase and combinations thereof to the slurry to convert some or all of the carbohydrate, such as dextrinized starch from the liquefication step, to maltose. The preferred first saccharification enzymes are either β-amylase, alone, or the combination of β-amylase and pullulanase. The first saccharification enzyme may be added in amounts of about 0.005 kilograms of enzyme per 100 kilograms of slurry at about 36° Bx to about 0.10 kilograms of enzyme per 100 kilograms of slurry at about 36° Bx, preferably from about 0.01 kilograms of enzyme per 100 kilograms of slurry at about 36° Bx to about 0.025 kilograms of enzyme per 100 kilograms of slurry at about 36° Bx. β-amylase available from Genencor Division, Rochester, N.Y. (“Genencor”) may be used. Pullulanase is available from Amano Pharmaceuticals, Japan. When β-amylase is used, either alone of in combination with pullulanase, the β-amylase may be added to the slurry in amounts of about 0.005 kilograms of β-amylase per 100 kilograms of slurry at about 36° Bx to about 0.020 kilograms of β-amylase per 100 kilograms of slurry at about 36° Bx, such as about 0.009 kilograms of β-amylase per 100 kilograms of slurry at about 36° Bx to about 0.015 kilograms of β-amylase per 100 kilograms of slurry at about 36° Bx. For example, about 0.0108 kilograms of the β-amylase may be added per 100 kilograms of slurry at about 36° Bx. When pullulanase is used for the first saccharification enzyme, pullulanase may be added to the slurry in amounts of about 0.015 kilograms of pullulanase per 100 kilograms of slurry at about 36° Bx to about 0.035 kilograms of pullulanase per 100 kilograms of slurry at about 36° Bx, such as about 0.020 kilograms of pullulanase per 100 kilograms of slurry at about 36° Bx to about 0.030 kilograms of pullulanase per 100 kilograms of slurry at about 36° Bx. For example, about 0.0252 kilograms of pullulanase may be added per 100 kilograms of slurry at about 36° Bx. The slurry is treated with the first saccharification enzyme for a period of about 15 hours to about 30 hours, preferably about 20 hours to about 24 hours at a temperature of about 50° C. to about 65° C., typically about 55° C. to about 60° C. at an alkaline pH, preferably about 4 to about 7, typically about 5.5 to about 5.8. The pH may be adjusted by the use of acids and/or alkali as discussed above.

After the first saccharification is complete one or more second saccharification enzymes are added to the slurry in the second saccharification step to convert some or all of the maltose to IMO, preferably IMO syrup. The second saccharification enzyme is preferably transglucosidase available from Genencor. The second saccharification enzyme, such as transglucosidase, may be added to the slurry in amounts of about 0.025 kilograms of enzyme per 100 kilograms of slurry at about 36° Bx to about 0.060 kilograms of enzyme per 100 kilograms of slurry at about 36° Bx, such as about 0.030 kilograms of enzyme per 100 kilograms of slurry at about 36° Bx to about 0.050 kilograms of enzyme per 100 kilograms of slurry at about 36° Bx. For example, about 0.036 kilograms of the transglucosidase may be added per 100 kilograms of slurry at about 36° Bx. After the second saccharification enzyme is added to the slurry, the slurry is treated for a period of about 30 hours to about 90 hours, preferably about 48 hours to about 72 hours at a temperature of about 50° C. to about 65° C., preferably about 55° C. to about 60° C. at an alkaline pH, typically about 4 to about 7, preferably about 5.5 to about 5.8. The pH may be adjusted by the use of acids and/or alkali as discussed above. The first saccharification step and second saccharification step are preferably performed as sequential steps in that the second saccharification enzyme is added to the slurry comprising maltose from the first saccharification step after the conversion of the raw material to maltose is complete or nearly complete.

After the saccharification, such as after the second saccharification step discussed above, foreign material, such as unreacted raw material, like unreacted carbohydrate, i.e., starch and the like, typically denatured protein from the raw material, is removed from the IMO syrup by the means for removal, for example filtration, sedimentation, coagulation and the like and combinations thereof. In an embodiment of the invention the IMO syrup is filtered in a filtration device, such as a drum filter. Preferred filtration devices are drum filters, such as rotary drum filters, using perlite, cellite or combinations thereof as filter aid and also filler presses.

Next the IMO syrup is decolorized by removing color inducing material. Generally, the decoloration step is achieved by treating the IMO syrup with a material capable of removing color inducing material, such as granular active carbon. In an embodiment, the IMO syrup is passed through a carbon tower that is charged with granular active carbon, preferably at a temperature of about 60° C. to about 90° C. The most preferred reaction temperature is about 70° C. to about 75° C. The IMO syrup may be processed through the carbon tower for about 5 hours to about 15 hours, preferably about 8 hours to about 10 hours, particularly on the basis of a 36° Bx solution.

After decoloration, ionic components are separated from the IMO syrup through the first means for separation which is capable of removing ionic species from the IMO syrup. An example of a first means for separation comprises one or more IMO ion exchange resins. Other examples of first means for separation include ultra filtration and reverse osmosis. The first separation step is conducted at a temperature of about 40° C. to about 75° C., preferably about 55° C. to about 60° C. For example, the IMO syrup may be contacted with one or more IMO ion exchange resins at a temperature of about 40° C. to about 75° C., preferably about 55° C. to about 60° C.

In embodiments of the invention, the first means for separation comprises cationic exchange resins, anionic exchange resins or combinations thereof. The used volume of cationic exchange resin may be about 0.1% to about 100%, such as about 1% to about 5%, based on the volume of the IMO syrup. The used volume of anionic exchange resin may be about 0.1% to about 100%, such as about 2% to 10%, based on the volume of the IMO syrup.

Ion exchange may be performed by flowing the IMO syrup through an ion exchange column filled with cationic exchange resin, anionic exchange resin or combinations thereof. Generally, the flow rate of the IMO syrup in the ion exchange column is about 0.1 ml/min to about 1000 l/min, such as at about 10 l/min to about 50 l/min.

In particular embodiments of the invention, the IMO syrup is processed first through a cationic exchange resin, then through an anionic exchange resin and then through a resin that comprises both cationic and anionic species. In aspects of the invention a transfortation pump is used to transfer the IMO syrup, preferably a 36° Bx syrup, first to a cation tower, then to an anion tower and then through a cation and anion mixed tower. The reaction temperature in this embodiment may be about 40° C. to about 75° C., but is preferably about 55° C. to about 60° C.

The IMO syrup is then concentrated, to a desired moisture content and/or solids content. Preferably, the IMO syrup is concentrated up to about 75° Bx. In embodiments of the invention, IMO syrup is concentrated to about 30° Bx to about 75° Bx, such as about 40° Bx to about 50° Bx, including about 45° Bx to about 50° Bx.

The IMO syrup is processed through the first means for removing moisture to concentrate the IMO syrup to a desired moisture content and/or solids content, for example evaporation of liquid from the IMO syrup. In a particular embodiment a MVR (Mechanical Vapor Recompressor, preferably a continuous type) is used, although other devices which will be known to one skilled in the art, such as a triple evaporator, can be used.

After concentration, the IMO syrup is hydrogenated, preferably with the use of a catalyst. Typical catalysts that may be used include platinum group metals, such as platinum, palladium, rhodium and ruthenium and also non-precious metal catalysts, such as those based on nickel, typically Raney nickel and Urushibara nickel. Nickel based catalysts are preferred. Typically, the IMO syrup is reacted with the catalyst, such as a nickel catalyst, by the addition of the catalyst to the concentrated IMO syrup. Generally an effective amount of catalyst is added to the IMO syrup to convert up to 100% of the IMO to IMO-H. The preferred sugar profile of the IMO syrup before and after conversion is set forth in the table below.

| Sugar profile of IMO | Sugar profile of IMO-H |
|---|---|
| before reaction | after reaction |
| Glucose | Sorbitol |
| Maltose | Maltitol |
| Maltotriose | Maltotriitol |
| Panose | Pannitol |
| Maltotetraose o | Maltotetriitol n |

The hydrogenation reaction temperature may be about 100° C. to about 250° C., such as about 110° C. to about 175° C., for example about 130° C. The reaction is preferably conducted at a pressure of about 10 bar to about 100 bar, typically about 25 bar to about 75 bar, preferably about 45 bar to about 55 bar, including about 50 bar. The reaction is preferably conducted at a pH of about 5.5 to about 7.5, typically about 6.5 to about 6.8. The reaction is conducted until the IMO is hydrogenated and converted into IMO-H having the sugar profile in the table above, for example about 1 hour to about 5 hours, including about 2 hours to about 4 hours, such as about 3 hours. After the reaction is complete, the catalyst is retrieved from the IMO-H syrup, generally by use of a chelated resin.

Next, a second ion exchange step is performed in a second means for separation to remove ionic components from the IMO-H syrup. The second means for separation is capable of removing ionic species from the IMO-H syrup. An example of a second means for separation comprises one or more IMO-H ion exchange resins. The second ionic exchange step may be conducted at a temperature of about 40° C. to about 75° C., preferably about 55° C. to about 60° C.

The second means for separation may be the same as the first means for separation, or it may be different but among the examples of devices discussed above with respect to the first separation step. For example, the IMO-H syrup is processed first through a cation ionic exchange resin, then through an anionic exchange resin and then through a resin that comprises both cationic and anionic species. In aspects of the invention a transfortation pump is used to transfer the IMO-H syrup first to a cation tower, then to an anion tower and then through a cation and anion mixed tower. The reaction temperature may be that discussed above with respect to the ionic component separation of the IMO syrup, but is preferably about 55° C. to about 60° C.

Finally, the IMO-H syrup is concentrated to a desired moisture content and/or solids content in a final concentration step. Preferably, the IMO-H syrup is concentrated up to about 100° Bx. In embodiments of the invention, IMO-H syrup is concentrated to about 40° Bx to about 90° Bx, such as about 50° Bx to about 80° Bx. In a particular embodiment of the invention, the IMO-H syrup is concentrated up to about 75° Bx, preferably up to about 60° Bx.

A second means for removing liquid is used in this final concentration step. The IMO-H syrup is processed through the second means for removing liquid to concentrate the IMO-H syrup to a desired moisture content and/or solids content. In a particular embodiment a MVR (Mechanical Vapor Recompressor, preferably a continuous type) is used to concentrate the IMO-H syrup, although other devices which will be known to one skilled in the art, such as a triple evaporator, can be used.

### Example

### A. Preparation of IMO Syrup

A starch slurry was prepared by adding 1 kg of corn starch and 1.5 kg of water into a vessel. Next, a liquefying enzyme, □-amylase, in an amount of 0.55 kg/kg starch was added to the starch slurry and the starch slurry was cooked at 105° C. to liquefy the starch. Then, the liquefied slurry was subject to a first saccharification step by adding β-amylase and pullulanase. Next, a second saccharification step was performed adding a 0.1% solution of transglucosidase enzyme and reacting at 55° C. to 60° C. for 48 hours. Unreacted materials were then removed from the saccharified solution by filtration and the saccharified solution was treated with activated carbon to remove color. Ionic components were then separated from the solution by ion exchange conducted at 30° C. to about 50° C. Finally the IMO syrup was concentrated to about 45° Bx to about 50° Bx.

### B. Preparation of IMO-H from IMO Syrup

The IMO syrup was then transferred to a high pressure reactor and Ni catalyst was added to the reactor to hydrogenate the IMO syrup. The hydrogenation reaction was conducted at about 100° C. to about 250° C. at a pH of about 6.5 to about 6.8 and a pressure of about 50 bar for about 3 hours. After hydrogenation, ionic components were separated from the IMO-H syrup by using an ion exchange process at about 10° C. to about 70° C. Finally, the IMO-H syrup was concentrated to more than 70° Bx in an evaporator.

1. A process for preparing isomaltooligosaccharide-hydrogenated (“IMOH”) comprising the steps of a) forming a slurry of one or more carbohydrates and liquid, b) liquefying the one or more carbohydrates with one or more liquefying enzymes, c) saccharifying the one or more carbohydrates with one or more saccharifying enzymes to obtain isomaltooligosaccharide (“IMO”) syrup, d) removing foreign material from the IMO syrup, e) decolorizing the IMO syrup, f) separating ionic components from the IMO syrup, g) concentrating the IMO syrup to a desired moisture content or solids content, h) hydrogenating the IMO syrup with a catalyst to obtain isomaltooligosaccharide-hydrogenated (UIMO-H”) syrup, i) separation of ionic components from the IMO-H syrup and j) concentrating the IMO-H syrup to a desired moisture content or solids content.

2. The process of claim 1 wherein the carbohydrate is selected from the group consisting of corn starch, wheat starch, tapioca, potato starch, sweet potato starch, sago starch, barley starch, heat/acid treated starch, pearl starch, waxy corn starch, Sorghum starch, high amylase corn starch, liquid dextrose and combinations thereof.

3. The process of claim 2 wherein the starch is corn starch.

4. The process of claim 1 wherein the liquefying enzyme is α-amylase.

5. The process of claim 1 wherein the one or more carbohydrates are liquefied in step b) at a temperature of about 95° C. to about 1250 C and pH of about 5 to about 8 for up to about 3 hours.

6. The process of claim 1 wherein, the one or more liquefying enzymes is about 0.40 kilogram of the liquefying enzyme per kilogram of slurry to about 0.70 kilogram of the liquefying enzyme per kilogram of the slurry.

7. The process of claim 1 wherein the one or more saccharifying enzymes are selected from the group consisting of β-amylase, transglucosidase, pullulanase and combinations thereof.

8. The process of claim 1 wherein the saccharifying step c) is conducted at temperatures from about 40° C. to about 900 C at an alkaline pH for about 12 hours to about 120 hours.

9. The process of claim 7 wherein the pH is about 5 to about 8.

10. The process of claim 1 wherein the amount of the one or more saccharifying enzymes are about 0.001% to about 0.15% based on the weight of the slurry.

11. The process of claim 1 wherein the saccharifying comprises a first saccharification step wherein a first saccharification enzyme is added to the slurry to convert some or all of the carbohydrate to maltose and a second saccharification step wherein a second saccharification enzyme is added to the slurry to convert some or all of the maltose to IMO.

12. The process of claim 11 wherein the first saccharification enzyme comprises β-amylase and pullulanase and the second saccharification enzyme is transglucosidase.

13. The process of claim 11 wherein the first saccharification step is conducted at a temperature of about 50° C. to about 65° C. and an alkaline pH for about 15 hours to about 30 hours.

14. The process of claim 11 wherein the second saccharification step is conducted at a temperature of about 50° C. to about 65° C. at an alkaline pH for a about 30 hours to about 90 hours.

15. The process of claim 1 wherein the foreign material is removed from the IMO syrup with a drum filter using filter aid selected from the group of perlite, cellite and combinations thereof.

16. The process of claim 1 wherein the separating of ionic components from the IMO syrup is conducted using one or more ion exchange resins.

17. (canceled)

18. (canceled)

19. (canceled)

20. The process of claim 1 wherein the catalyst is nickel.

21. The process of claim 1 wherein the hydrogenation occurs at a temperature of about 100° C. to about 250° C., a pressure of about 10 bar to about 100 bar and a pH of about 5.5 to about 7.5.

22. The process of claim 1 wherein the ionic components are separated from the IMO-H syrup by one or more ion exchange resins.

23. (canceled)

24. The process of claim 1 wherein the IMO-H syrup is concentrated up to about 100° Bx.

25. (canceled)
